(19) United States
(12) Patent Application Publication
(10) Pub. No.: US 2009/0064697 A1
(43) Pub. Date: Mar. 12, 2009

(54) Air conditioning system

(76) Inventors: Tetsuyuki Kondo, Shiga (JP); Nobuki Matsui, Osaka (JP)

Correspondence Address: BIRCH STEWART KOLASCH & BIRCH, PO BOX 747, FALLS CHURCH, VA, 22040-0747, US

(21) Appl. No.: 11/920,243

(22) PCT Filed: May 22, 2006
(86) PCT No.: PCT/JP2006/310162

§ 371 Date: Nov. 13, 2007

(30) Foreign Application Priority Data
May 24, 2005 (JP) 2005-150792

(51) Int. Cl. F25D 23/00; G05B 15/00

(52) U.S. Cl. 62/271; 700/278

(57) ABSTRACT

An air conditioning system (1) including a demand control device (10) that controls the total amount of the working power of a plurality of air conditioning loads is provided with, in order to improve comfortableness under demand control, an air conditioner (20) including a refrigerant circuit and dominantly processes an indoor sensible heat load and a humidity controller (30) which includes adsorption members (32, 33) and dominantly processes a latent heat load. According to a set level of a plurality of demand control levels, the evaporation temperature of the refrigerant circuit composing the air conditioner (20) is controlled while the indoor humidity is adjusted by the humidity controller (30).

### TECHNICAL FIELD

The present invention relates to air conditioning systems including a demand control device for controlling the total amount of the working power of a plurality of air conditioning loads.

### BACKGROUND ART

Conventionally, as a device for contemplating energy saving in installation, such as a building, there is a demand control device that controls loads so as to prevent a peak power from exceeding a predetermined range (for example, see Patent Document 1). In general, the demand control device controls operations of load appliances so that the average power used in a predetermined time period (30 minutes in general) does not exceeds a contract power set with a power company. When the power would almost exceed the contract power, the demand control device issues a load peak cut instruction to control the capacities of an air conditioner (a multi-type building air conditioner), illumination equipment, and the like in each room of the building.

The air conditioning system including the demand control device of Patent Document 1 separately controls air conditioning loads of: a first load as a demand control target (air conditioners installed in an assembly room, an office room, a guest room, and the like) and a second load as an energy saving control target (air conditioners installed in an executive room, a director's room, a reception room, and the like) rather than the demand control target. As to the first load, the demand control is set to have eight levels and the order of precedence for controlling the rooms is set. A target demand control level is judged on the basis of the working power per unit time period predicted from the demand at the control time (current demand), and the control is performed in accordance with the order of precedence for the rooms.

Specifically, as indicated in the table of FIG. 4, when the demand control level is set low (when the demand control level is set at level 1 or 2), there are performed control of the capacity of the outdoor unit in the air conditioner (the capacity of the compressor is reduced to 70%, for example) and control of the number of the indoor units in operation. When the demand control level is slightly increased (when the control level is set at level 3 or 4), the number of indoor units in operation is controlled with the capacity of the outdoor unit further suppressed (for example, reduced to 40%). When the demand control level is further increased (when the control level is set at level 5, 6, or 7), the set target temperature is changed by ON/OFF control of the indoor units in some rooms in addition. When the demand control level is a maximum (level 8), only an air blowing operation is performed as a thermo-off operation mode compulsorily in all the rooms as with the outdoor unit stopped. In this way, the air conditioning system of Patent Document 1 performs considerable power suppression as the demand control level is increased.

As to the second load in the device of Patent Document 1, the operation is controlled so as to reduce power consumption to the extent that the operation state does not substantially vary regardless of transition of power consumption.

### Patent Document 1: Japanese Patent Application Laid Open Publication No. 2002-142360

### SUMMARY OF THE INVENTION

Problems that the Invention is to Solve

In the above air conditioning system, as indicated in the table of FIG. 5, though the target air conditioning capacity can be almost attained when the demand control level (predicted overage of the power) is set low, adherence to the target power sacrifices comfortableness when the demand control level is set high.

Particularly, in multi-type building air conditioners, the circumstances control the humidity in general, and therefore, change of the set target temperature by ON/OFF control of an indoor unit increases the humidity significantly in summer to lower the comfortableness significantly.

The present invention has been made in view of the foregoing and has its object of improving comfortableness under demand control in an air conditioning system including a demand control device that controls the total amount of the working power of a plurality of air conditioning loads.

### Means for Solving the Problems

A first aspect of the present invention is directed to an air conditioning system including a demand control device (10) which controls a total amount of working power of a plurality of air conditioning loads. Wherein, the air conditioning system further includes: an air conditioner (20) which includes a refrigerant circuit and dominantly processes an indoor sensible heat load; and a humidity controller (30) which includes an adsorption member (32, 33) and dominantly processes an indoor latent heat load, wherein the demand control device (10) controls an evaporation temperature of the refrigerant circuit composing the air conditioner (20) according to a set level of a plurality of demand control levels.

In the first aspect of the present invention, the indoor sensible heat load is processed in the air conditioner (20) while the indoor latent heat load is processed in the humidity controller (30). Under the demand control, the evaporation temperature of the refrigerant circuit is controlled according to a set level of the demand control levels. For example, in a cooling operation, setting the evaporation temperature high as the demand control level is increased results in control for suppressing power consumption. On the other hand, in this aspect, the indoor latent heat load is processed in the humidity controller (30) under the demand control at any demand control level. Hence, an increase in indoor humidity can be suppressed.

Referring to a second aspect of the present invention, in the first aspect, the demand control device (10) performs control for reducing a capacity of the air conditioner (20) as the demand control level is increased. In this aspect, for example, not each of the control for increasing the evaporation temperature of the refrigerant circuit in the air conditioner (20) and the control for reducing the capacity of the air conditioner (20) is performed at each increase of the demand control level. In other words, when the demand control level is changed by one level, the evaporation temperature may be increased merely with the capacity of the air conditioner (20) maintained, or in reverse, the capacity of the air conditioner (20) may be reduced merely with the evaporation temperature maintained.

In the second aspect of the present invention, when the demand control level is set high, the operation capacity of the variable capacity compressor is reduced, for example, to reduce the capacity of the air conditioner (20), thereby reducing the power consumption. The indoor latent heat load can be processed in the humidity controller (30) even under this demand control, thereby suppressing an increase in indoor humidity.

Referring to a third aspect of the present invention, in the first or second aspect, during demand control, the demand control device (10) controls the humidity controller (30) on the basis of a set target temperature or an indoor temperature so as to attain a predetermined relative humidity.

In the third aspect of the present invention, under the demand control, the operation of the humidity controller (30) is controlled on the basis of the set target indoor temperature or the actual indoor temperature so as to attain a predetermined relative humidity. For example, the operation control thereof is performed on the basis of a higher one of the set target indoor temperature and the actual indoor temperature so as to attain the predetermined relative humidity. This suppresses an increase in indoor humidity even when the indoor temperature increases.

Referring to a fourth aspect of the present invention, in any one of the first to third aspects, the demand control device (10) sets the air conditioner (20) to a thermo-off operation mode when the demand control level is set at a maximum level. Herein, the thermo-off operation mode means an air blowing operation with the refrigerant circuit of the air conditioner (20) stopped.

In the fourth aspect of the present invention, when the demand control level is set at the maximum level, the demand control device (10) compulsorily sets the air conditioner (20) to the thermo-off operation mode. This suppresses an increase in power consumption further definitely. In addition, even when the demand control level is set at the maximum level, the indoor latent heat load can be processed in the humidity controller (30). Hence, an increase in indoor humidity can be suppressed even in this state.

Referring to a fifth aspect of the present invention, in any one of the first to fourth aspects, the humidity controller (30) is capable of operating in a ventilation mode, and the demand control device (10) sets the humidity controller (30) to the ventilation mode when the demand control level is set at a maximum level.

In the fifth aspect of the present invention, when the demand control level is set at the maximum level, the demand control device (10) sets the humidity controller (30) to the ventilation mode. In the mode of performing only ventilation, the humidity control is unnecessary, thereby simplifying the control to suppress power consumption.

Referring to a sixth aspect of the present invention, in any one of the first to fifth aspects, the humidity controller (30) includes a refrigerant circuit including a first adsorption heat exchanger (32) and a second adsorption heat exchanger (33) each having a surface carrying an adsorbent, a first air passage through which outdoor air flows indoors, and a second air passage through which indoor air flows outdoors, the refrigerant circuit is switchable between a first refrigerant flowing state and a second refrigerant flowing state, the first refrigerant flowing state being a state that the first adsorption heat exchanger (32) serves as an evaporator while the second adsorption heat exchanger (33) serves as a condenser, and the second refrigerant flowing state being a state that the second adsorption heat exchanger (33) serves as an evaporator while the first adsorption heat exchanger (32) serves as a condenser, and the air passages are switchable between a first air flow state and a second air flow state, the first air flow sate being a state that the outdoor air flows indoors through the first adsorption heat exchanger (32) while the indoor air flow outdoors through the second adsorption heat exchanger (33), and the second air flow state being a state that the outdoor air flows indoors through the second adsorption heat exchanger (33) while the indoor air flows outdoors through the first adsorption heat exchanger (32).

In the sixth aspect of the present invention, the adsorbent of the adsorption heat exchanger (32 or 33) serving as an evaporator adsorbs moisture in the air to dehumidify the air while the adsorbent of the adsorption heat exchanger (33 or 32) serving as a condenser releases moisture to the air to regenerate the adsorbent thereof. Accordingly, for example, when the refrigerant circuit is set to the first refrigerant flowing state when the air passage is switched to the first air flow state and is set to the second refrigerant flowing state when the air passage is switched to the second air flow state, a dehumidifying operation for dehumidifying and supplying indoors the outdoor air can be performed continuously.

### Effects of the Invention

In the present invention, in the system in which the air conditioner (20) and the humidity controller (30) separately process the indoor sensible heat load and the indoor latent heat load, respectively, the evaporation temperature of the refrigerant circuit is controlled during the demand control to suppress the working power. In this state, the humidity controller (30) is set to process the indoor latent heat load. Accordingly, an increase in humidity can be suppressed even when the indoor temperature increases, thereby suppressing an increase in sensible temperature to improve comfortableness under the demand control (to let a person feeling more cooler than at the actual temperature) more than in the conventional one.

In the second aspect of the present invention, the capacity of the air conditioner (20) is reduced as the demand control level is increased, thereby suppressing an increase in power consumption further definitely. Moreover, the indoor latent heat load can be processed in the humidity controller (30) even under the demand control at such a level to suppress an increase in indoor humidity, thereby improving the comfortableness more than in the conventional one.

In the third aspect of the present invention, the operation of the humidity controller (30) is controlled on the basis of the set target indoor temperature or the actual indoor temperature so as to attain the predetermined relative humidity, thereby suppressing an increase in indoor humidity definitely. Hence, the indoor comfortableness can be improved more than in the conventional one, similarly to the first and second aspects of the present invention.

In the fourth aspect of the present invention, when the demand control level is set at the maximum level, the air conditioner (20) is compulsorily set to the thermo-off operation mode. This suppresses an increase in power consumption further definitely. Further, the humidity controller (30) can continue operating even in this state, preventing considerable lessening of the indoor comfortableness.

In the fifth aspect of the present invention, when the demand control level is set at the maximum level, the humidity controller (30) is set to the ventilation mode. In the mode for performing only ventilation, humidity control is unnecessary, and therefore, the control is simplified, thereby suppressing power consumption. Further, continuation of ventilation even during the time when the air conditioner (20) is stopped prevents an excessive increase in indoor humidity.

In the sixth aspect of the present invention, the humidity controller (30) includes the refrigerant circuit including the two adsorption heat exchangers (32, 33), the first air passage through which the outdoor air flows indoors, the second air passage through which the indoor air flows outdoors, and the refrigerant circuit is switchable between the first refrigerant flowing state and the second refrigerant flowing state, and the air passages are switchable between the first air flow state and the second air flow state. Accordingly, for example, when the refrigerant circuit is set to the first refrigerant flowing state when the air passages are switched to the first air flow state and is set to second refrigerant flowing state when the air passages are switched to the second air flow state, the dehumidifying operation for dehumidifying and supplying indoors the outdoor air can be performed continuously. Simultaneous performance of this operation with the evaporation temperature control in the refrigerant circuit of the air conditioner (20) can suppress lowering of the indoor comfortableness.

### BRIEF DESCRIPTION OF THE DRAWINGS

FIG. 1 is a configuration diagram of an air conditioning system in accordance with an embodiment of the present invention.

FIG. 2 is a table indicating each operation control of an air conditioner and a humidity controller at each demand control level in the air conditioning system of FIG. 1.

FIG. 3 is a table indicating the relationship between the demand control levels and comfortableness in the air conditioning system of FIG. 1.

FIG. 4 is a table indicating each operation control of an air conditioner and a humidity controller at each demand control level in a conventional air conditioning system.

FIG. 5 is a table indicating the relationship between the demand control levels and comfortableness in the conventional air conditioning system.

### EXPLANATION OF REFERENCE NUMERALS

1 air conditioning system
10 demand control device
20 air conditioner
30 humidity controller
32 first adsorption heat exchanger (adsorption member)
33 second adsorption heat exchanger (adsorption member)

### BEST MODE FOR CARRYING OUT THE INVENTION

Embodiments of the present invention will be described below in detail with reference to the accompanying drawings.

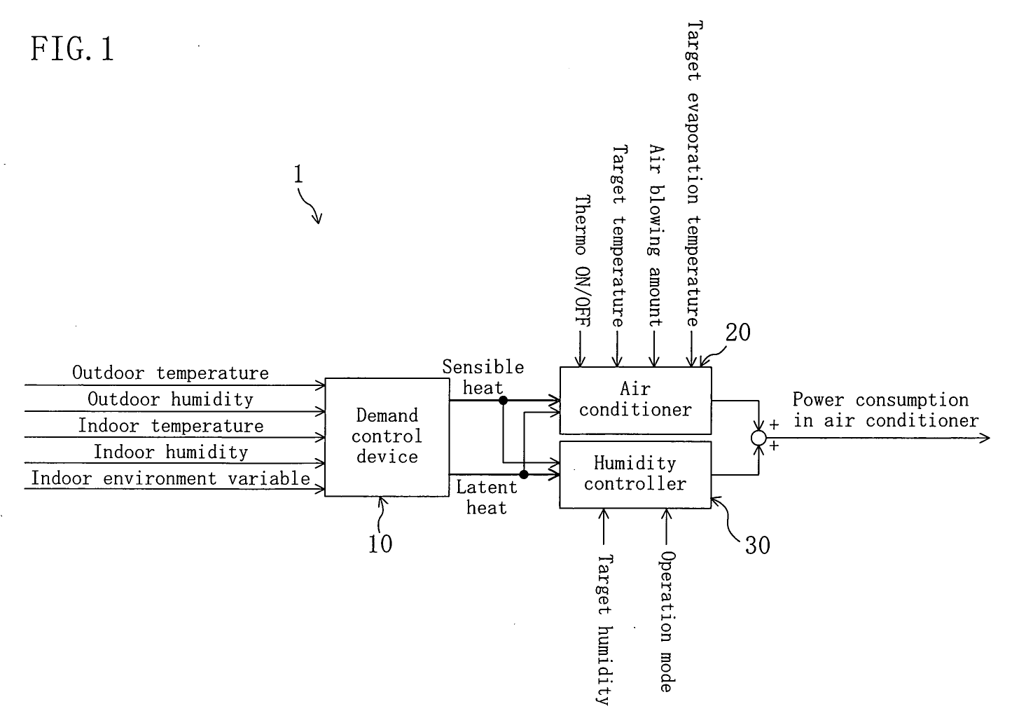

An air conditioning system (1) shown in FIG. 1 in the present embodiment is an air conditioning system (1) including a demand control device (10) that controls the total amount of the working power of a plurality of air conditioning loads and includes an air conditioner (20) which dominantly processes the indoor sensible heat load and a humidity controller (30) which dominantly processes the indoor latent heat load. In other words, the air conditioning system (1) is a system for separately processing the indoor sensible heat load and the indoor latent heat load.

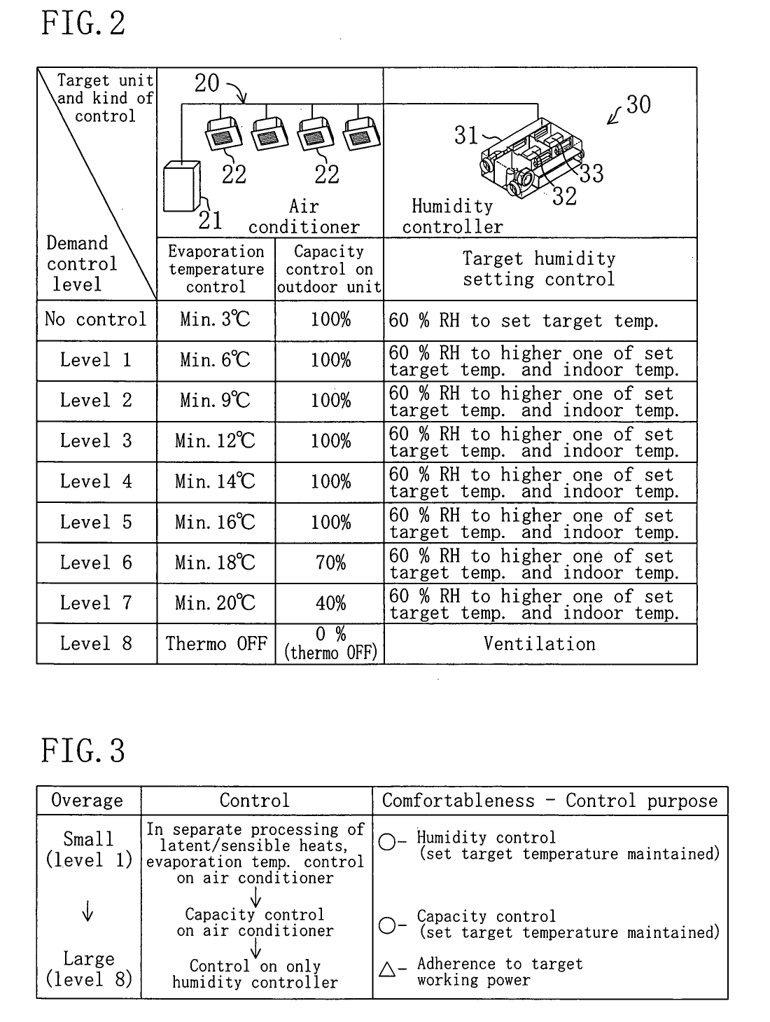

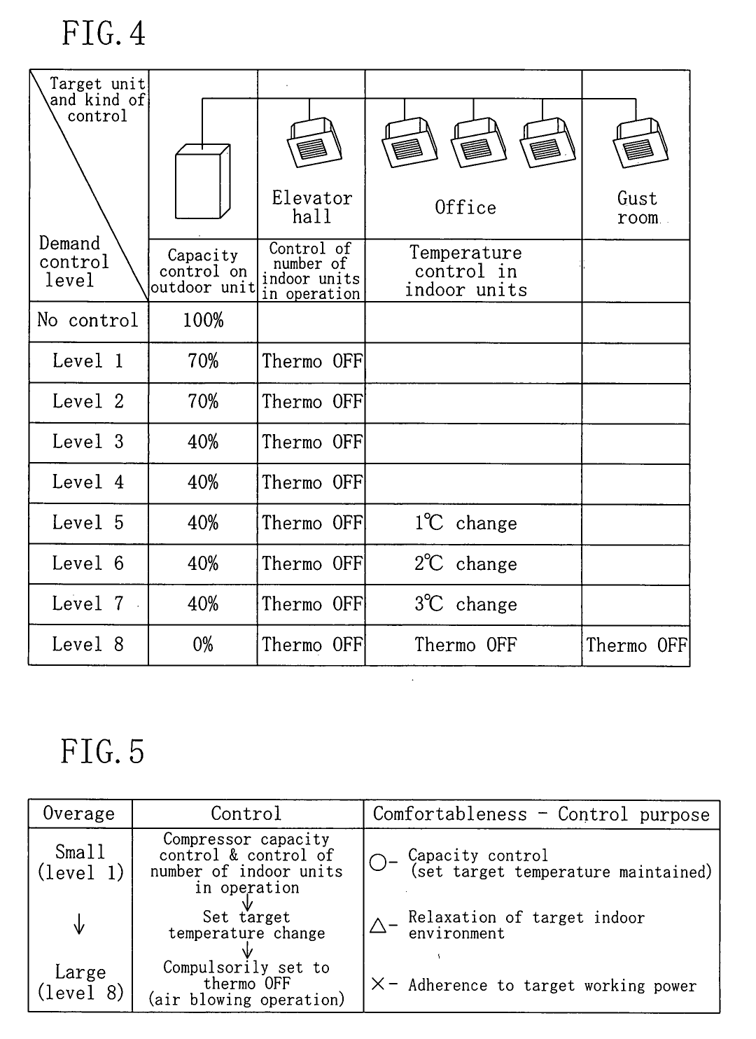

The air conditioner (20) includes, though not shown, a refrigerant circuit that performs a refrigeration cycle of vapor compression type. The air conditioner (20) is of a generally-called multi-type building air conditioner (20) in which a plurality of indoor units (22) are connected to one outdoor unit (21), as shown in FIG. 2.

FIG. 2 includes a perspective view showing an inside structure of the humidity controller (30). The humidity controller (30) is a humidity controller (30) capable of operating in a ventilation mode and includes two adsorption members (32, 33) accommodated in a casing (31) thereof. The adsorption members (32, 33) are composed as two heat exchangers included in a refrigerant circuit other than the refrigerant circuit of the air conditioner (20). Each adsorption member (32, 33) (hereinafter referred to them as first adsorption heat exchanger (32) and a second adsorption heat exchanger (33)) is composed of a fin-and-tube heat exchanger of cross-fin type carrying at the surface thereof an adsorbent.

The refrigerant circuit of the humidity controller (30) is switchable between a first refrigerant flowing state and a second refrigerant flowing state, wherein the first refrigerant flowing state is a state that the first adsorption heat exchanger (32) serves as an evaporator while the second adsorption heat exchanger (33) serves as a condenser, and the second refrigerant flowing state is a state that the second adsorption heat exchanger (33) serves as an evaporator while the first adsorption heat exchanger (32) serves as a condenser. When either of the adsorption heat exchangers (32, 33) serves as an evaporator, moisture in the air is adsorbed into the adsorbent thereof, thereby dehumidifying the air. When either of the adsorption heat exchangers (33, 32) serves as a condenser, moisture in the adsorbent thereof is released to the air, thereby regenerating the adsorbent thereof.

Though not shown in detail, the humidity controller (30) includes within the casing (31) a first air passage through which the outdoor air flows indoors and a second air passage through which the indoor air flows outdoors. The air passages are switchable between a first air flow state and a second air flow state, wherein the first air flow state is a state that the air flowing indoors from the outdoor passes through the first adsorption heat exchanger (32) while the air flowing outdoors from the indoor passes through the second adsorption heat exchanger (33), and the second air flow state is a state that that the air flowing indoors from the outdoor passes through the second adsorption heat exchanger (33) while the air flowing outdoors from the indoor passes through the first adsorption heat exchanger (32).

With the above arrangement, when the humidity controller (30) is set in such a fashion that the refrigerant circuit is set to the first refrigerant flowing state when the air passages are switched to the first air flow state and the refrigerant circuit is set to the second refrigerant flowing state when the air passages are switched to the second air flow state, a dehumidification operation for dehumidifying and supplying indoors the outdoor air can be performed continuously.

The demand control device (10) judges every unit time (30 minutes in general) a target demand control level on the basis of the working power predicted from the current demand, and performs demand control. The demand control is performed in such a manner that the demand control device (10) calculates the indoor sensible heat load and the indoor latent heat load on the basis of an indoor environment variable obtained from an outdoor temperature, an outdoor humidity, an indoor temperature, an indoor humidity, and each room condition, and separately controls the air conditioner (20) and the humidity controller (30) on the basis of the calculated loads. The order of precedence for the rooms may be set in the demand control.

Description will be given about a specific operation in the demand control.

As indicated in FIG. 2, eight demand control levels are set in the demand control device (10). Control on the evaporation temperature of the refrigerant circuit of the air conditioner (20) is performed according to a set level of the eight demand control levels. Specifically, when no demand control is performed, the air conditioner (20) operates with the evaporation temperature set at 3° C., the lowest temperature. At the demand control levels 1 to 7, the higher the demand control level is set, the higher the evaporation temperature is set step by step. When the demand control level is set at level 8, a maximum level, the demand control device (10) stops the refrigerant circuit of the air conditioner (20) and allows the air conditioner (20) to operate in a thermo-off operation mode (air blowing mode).

Under the demand control, the demand control device (10) performs capacity control of the outdoor unit (21) of the air conditioner (20) in addition to the evaporation temperature control. Specifically, the higher the demand control level is set, the more the demand control device (10) performs control for reducing the capacity (an operation volume of the variable capacity compressor) of the outdoor unit (21) of the air conditioner (20). In the example shown in the drawing, the capacity is set to 100% at the demand control levels from level 1 to level 5; set to 70% at level 6; set to 40% at level 7; and set to 0% at level 8.

In the example shown in FIG. 2, when the demand control level is transferred, for example, from level 5 to level 6, both of the control for increasing the evaporation temperature of the refrigerant circuit from 16° C. to 18° C. and control for reducing the capacity of the outdoor unit (21) from 100% to 70% are performed. An intermediate level may be provided. For example, there may be provided a control level for reducing the capacity of the outdoor unit (21) to 70% with the evaporation temperature maintained at 16° C., a control level for raising the evaporation temperature to 18° C., in reverse, with the capacity of the outdoor unit (21) maintained at 100%, like control at transition of the demand control level between level 1 and level 5, and the like. This may be applied to transition from level 6 to level 7, as well.

When the demand control is not performed, the humidity controller (30) is controlled so as to aim at a relative indoor humidity of 60% relative to the set target temperature. This control can be achieved by controlling the intervals of each switching time of the refrigerant circuit and the air passages of the humidity controller (30). Because: the adsorbents have a characteristic that they adsorbs much amount of moisture at the initial stage and the adsorption amount decreases as time elapses; and, therefore, when the intervals of each switching time set short, the adsorption amount can be kept larger, thereby increasing the latent heat processing capacity. In other words, longer intervals of each switching time lead to lowering of the latent heat processing capacity.

The humidity controller (30) is controlled during the time when the demand control is set to any of levels 1 to 7 so as to attain a relative humidity of 60% relative to a higher one of the set target indoor temperature and the actual indoor temperature (detection temperature). This control is performed for suppressing lowering of the comfortableness by suppressing an increase in humidity even when the indoor temperature increases. For attaining this control, various kinds of operation conditions are controlled, such as the evaporation temperature of the refrigerant circuit of the humidity controller (30), the air blowing amounts of the air passages, and the like. When the demand control level is set at level 8, the maximum level, the demand control device (10) stops the refrigerant circuit of the humidity controller (30) and allows the humidity controller (30) to operate in the ventilation mode.

As described above, during the operation of the air conditioning system (1) of the present embodiment, the demand control device (10) controls the air conditioner (20) and the humidity controller (30) separately to process the indoor sensible heat load and the indoor latent heat load. Under the demand control performed on the basis of the working power per unit time predicted from the current demand, the demand control device (10) performs the evaporation temperature control and the outdoor unit capacity control in the air conditioner (20) and the target humidity setting control in the humidity controller (30) according to the set demand control level to maintain the comfortableness with the working power suppressed within the range of the contract power.

Specifically, when the demand control level is set low (from level 1 to level 5), the demand control device (10) performs the target humidity setting control in the humidity controller (30) while performing only the evaporation temperature control in the air conditioner (20). This suppresses an increase in humidity even when the indoor temperature increases to suppress an increase in sensible temperature, thereby suppressing lowering of the comfortableness.

When the demand control level is set high (levels from 6 to level 7), the outdoor unit capacity control is performed in addition. When the demand control level is set at the maximum level (level 8), the air conditioner (20) is set to the thermo-off operation mode while the humidity controller (30) is set to the ventilation mode, thereby definitely suppressing the working power within the range of the contract power.

### Effects of Embodiment

As described above, in the present embodiment, in the system that processes the indoor sensible heat load and the indoor latent heat load separately by the air conditioner (20) and the humidity controller (30), suppression of the working power is achieved basically by controlling the evaporation temperature of the refrigerant circuit during the demand control. The humidity controller (30) can continue the processing of the indoor latent heat load even in this state. Accordingly, even when the indoor temperature increases, an increase in humidity is suppressed, thereby suppressing lowering of the comfortableness during the demand control, as indicated in FIG. 3.

When the demand control level is set high, the capacity of the air conditioner (20) is controlled to be reduced, leading to definite suppression of an increase in power consumption.

Furthermore, under the demand control, the operation of the humidity controller (30) is controlled on the basis of a higher one of the set target indoor temperature and the actual indoor temperature so as to attain a relative humidity 60%, contemplating maintenance of the comfortableness with an increase in indoor humidity suppressed definitely.

In addition, when the demand control level is set at the maximum level, the air conditioner (20) is set to the thermo-off operation mode compulsorily to suppress an increase in power consumption further definitely. In this state, the humidity controller (30) is set to the ventilation mode so that control for humidity adjustment becomes unnecessary, resulting in further suppression of power consumption and suppression of lowering of the comfortableness, as indicated in the table of FIG. 3

### OTHER EMBODIMENTS

The above embodiment may have any of the following arrangements.

In the above embodiment, the air conditioner (20) is of multi-type composed of the one outdoor unit (21) and the plurality of indoor units (22), but may be of generally-called paired type, rather than the multi-type, composed of one outdoor unit (21) and one indoor unit (22), for example.

The humidity controller (30) includes the adsorption heat exchangers (32, 33) as the adsorption members (32, 33) having functions of a cooler (an evaporator) and a heater (a condenser), but may include an adsorption member, a cooler, and a heater separately. Alternatively, the humidity controller (30) may include as a Peltier effect element adsorption members (32, 33) of which obverse faces and reverse faces are coated with an adsorbent so that the adsorbent performs moisture adsorption/desorption by alternately switching the polarity of the DC power source between plus and minus.

In the above embodiment, the humidity controller (30) is set to the ventilation mode when the demand control is set at level 8, the maximum level. At level 8, the operation of the humidity controller (30) may be controlled on the basis of a higher one of the set indoor temperature and the actual indoor temperature so as to attain a relative humidity of 60%, similarly to the control at levels 1 to 7. This attains an indoor-comfortableness-conscious operation.

The specific control in each control level of the demand control described in the above embodiment is a mare example, and any appropriate modification may be employed for setting the evaporation temperature in the air conditioner (20), setting the capacity of the outdoor unit (21), setting the relative humidity in the humidity controller (30), and the like.

It is noted that the above embodiments are mere essentially preferred examples and are not intended to limit the present invention, applicable matters, and the scope of use.

### INDUSTRIAL APPLICABILITY

As described above, the present invention is useful for air conditioning systems including a demand control device that controls the total amount of the working power of a plurality of air conditioning loads.

1. An air conditioning system comprising:
a demand control device (10) which controls a total amount of working power of a plurality of air conditioning loads;
an air conditioner (20) which includes a refrigerant circuit and dominantly processes an indoor sensible heat load; and
a humidity controller (30) which includes an adsorption member (32, 33) and dominantly processes a latent heat load,
wherein the demand control device (10) controls an evaporation temperature of the refrigerant circuit composing the air conditioner (20) according to a set level of a plurality of demand control levels.

2. The air conditioning system of claim 1,
wherein the demand control device (10) performs control for reducing a capacity of the air conditioner (20) as the demand control level is increased.

3. The air conditioning system of claim 1,
wherein during demand control, the demand control device (10) controls the humidity controller (30) on the basis of a set target temperature or an indoor temperature so as to attain a predetermined relative humidity.

4. The air conditioning system of claim 1,
wherein the demand control device (10) sets the air conditioner (20) to a thermo-off operation mode when the demand control level is set at a maximum level.

5. The air conditioning system of claim 1,
wherein the humidity controller (30) is capable of operating in a ventilation mode, and
the demand control device (10) sets the humidity controller (30) to the ventilation mode when the demand control level is set at a maximum level.

6. The air conditioning system of claim 1,
wherein the humidity controller (30) includes a refrigerant circuit including a first adsorption heat exchanger (32) and a second adsorption heat exchanger (33) each having a surface carrying an adsorbent, a first air passage through which outdoor air flows indoors, and a second air passage through which indoor air flows outdoors,
the refrigerant circuit is switchable between a first refrigerant flowing state and a second refrigerant flowing state, the first refrigerant flowing state being a state that the first adsorption heat exchanger (32) serves as an evaporator while the second adsorption heat exchanger (33) serves as a condenser, and the second refrigerant flowing state being a state that the second adsorption heat exchanger (33) serves as an evaporator while the first adsorption heat exchanger (32) serves as a condenser, and
the air passages are switchable between a first air flow state and a second air flow state, the first air flow sate being a state that the outdoor air flows indoors through the first adsorption heat exchanger (32) while the indoor air flow outdoors through the second adsorption heat exchanger (33), and the second air flow state being a state that the outdoor air flows indoors through the second adsorption heat exchanger (33) while the indoor air flows outdoors through the first adsorption heat exchanger (32).
